(19) United States
(12) Patent Application Publication
(10) Pub. No.: US 2012/0050160 A1
(43) Pub. Date: Mar. 1, 2012

(54) METHOD AND APPARATUS FOR MEASURING OF A THREE-DIMENSIONAL POSITION OF MOUSE PEN

(75) Inventor: Goksel Dedeoglu, Plano, TX (US)

(73) Assignee: TEXAS INSTRUMENTS INCORPORATED, Dallas, TX (US)

(21) Appl. No.: 13/223,914

(22) Filed: Sep. 1, 2011

Related U.S. Application Data
(60) Provisional application No. 61/379,110, filed on Sep. 1, 2010.

(51) Int. Cl. G06F 3/033

(52) U.S. Cl. 345/157

(57) ABSTRACT

A method, apparatus and system of an improved mouse-pen device. The method includes projecting structured light pattern, measuring the intensity of the projected light, determining the improved mouse-pen location with respect to a projector, determining the next structured light pattern to infer the position and shape of the light sensing cone of the improved mouse-pen device utilizing the light intensity data and location with respect to the projector, and determining the three position of the improved mouse-pen device utilizing the inferred position and shape.

### CROSS-REFERENCE TO RELATED APPLICATIONS

This application claims benefit of U.S. provisional patent application Ser. No. 61/379,110, filed Sep. 1, 2010, which is herein incorporated by reference.

### BACKGROUND OF THE INVENTION

1. Field of the Invention

Embodiments of the present invention generally relate to a method and apparatus for measuring of a three-dimensional position of a mouse pen.

2. Description of the Related Art

A traditional mouse-pen system consists of three components which are a projector, a mouse-pen and a closed-loop algorithm. The projector, such as, a DLP projector, is usually in addition to projecting usual display content, generate special patterns on the screen. The latter remain invisible to the human observer but can be seen by an optical sensor. The mouse-pen with a single optical sensor and wireless connection to the projector. The mouse-pen is time-synchronized with the projector so that the readings of the special patterns can be separated from others. The closed-loop control algorithm is the strength of the current optical reading is used to decide on the next special pattern to be projected in projector. Using such a loop, the mouse-pen is capable of estimating where, on the screen, the mouse-pen is pointing at.

The mouse-pen is designed as a positioning device, just like a mouse. Hence, the objective is to move the cursor on the two-dimensional screen. Buttons on the mouse-pen enable left/right mouse clicks as usual.

However, such a system is not capable of inferring three-dimensional position of the mouse-pen with respect to the projection screen. Therefore, there is a need for an improved method and apparatus for a mouse-pen

### SUMMARY OF THE INVENTION

Embodiments of the present invention relate to a method, apparatus and system of an improved mouse-pen device. The method includes projecting structured light pattern, measuring the intensity of the projected light, determining the improved mouse-pen location with respect to a projector, determining the next structured light pattern to infer the position and shape of the light sensing cone of the improved mouse-pen device utilizing the light intensity data and location with respect to the projector, and determining the three position of the improved mouse-pen device utilizing the inferred position and shape.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a working principle of an improved mouse-pen system;

FIG. 2 is an embodiment of an improved mouse-pen system where human motion provides enough constraints to eliminate implausible the mouse-pen locations;

FIG. 3 is an embodiment of a block diagram for an improved mouse-pen system; and

FIG. 4 is an embodiment of a flow diagram for a method for operating an improved mouse-pen system.

### DETAILED DESCRIPTION

There is a need for a method and apparatus that is capable if inferring a three-dimensional (3D) position of a mouse-pen with respect to the projection screen without interfering with the traditional mouse role of the mouse-pen. In one embodiment, the projection surface is planar, the field-of-view of the optical sensor is a small 3D cone, approx. 1-2 degrees of solid angle, under projective geometry, the intersection of the above cone with the projection surface is mathematically known to be a conic [1, 2, 3], and the detection and characterization of the conic can be used to determine the three-dimensional position of the mouse-pen.

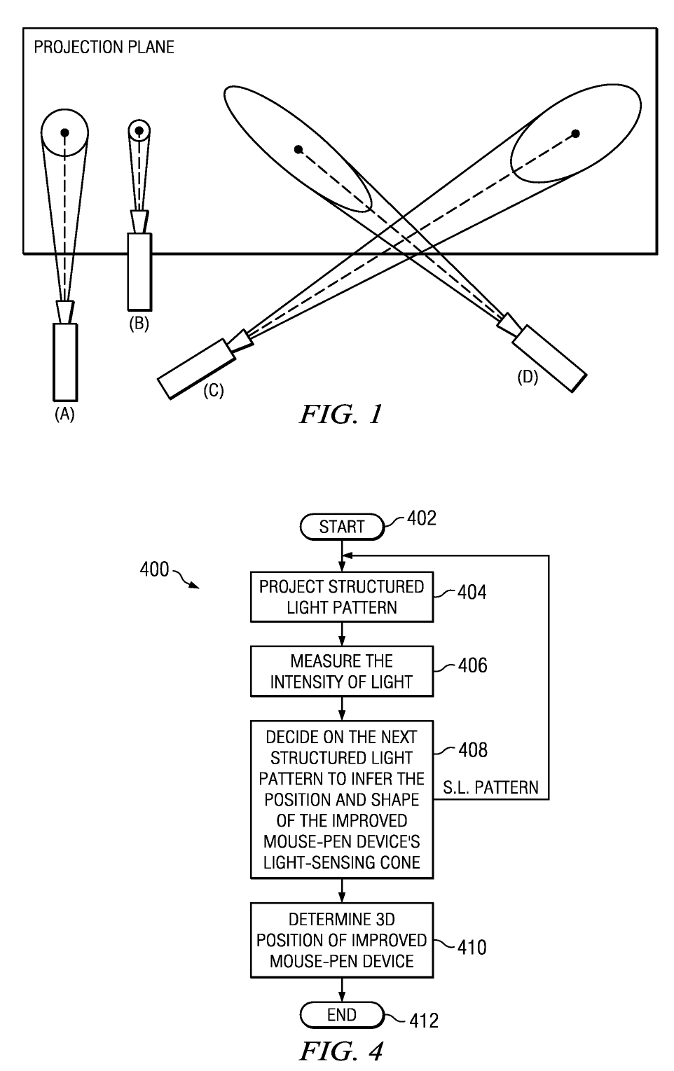

FIG. 1 is an embodiment of a working principle of an improved mouse-pen system. The traditional mouse-pen operates by estimating the two-dimensional position of the centroid of the conics on the screen. These points are shown as black disks in black, traced to the mouse-pen with a dashed line. The improved mouse-pen system estimates not the location of the centroid and the shape of the conic as projected (or induced) on the screen.

In FIG. 1, four different mouse-pen devices are shown. (A) and (B) represent a projected conic growing in size when the mouse-pen gets farther from the screen. Whereas, (C) and (D) show that the cone shape reveals the relative orientation of the mouse-pen with respect to the screen.

Thus, the cross section of a three-dimensional cone with a planar surface is Conic [1, 2, 3]. When estimating the location and shape of such a conic, the improved mouse-pen estimates the three-dimensional position of the mouse-pen device with respect to the projection screen.

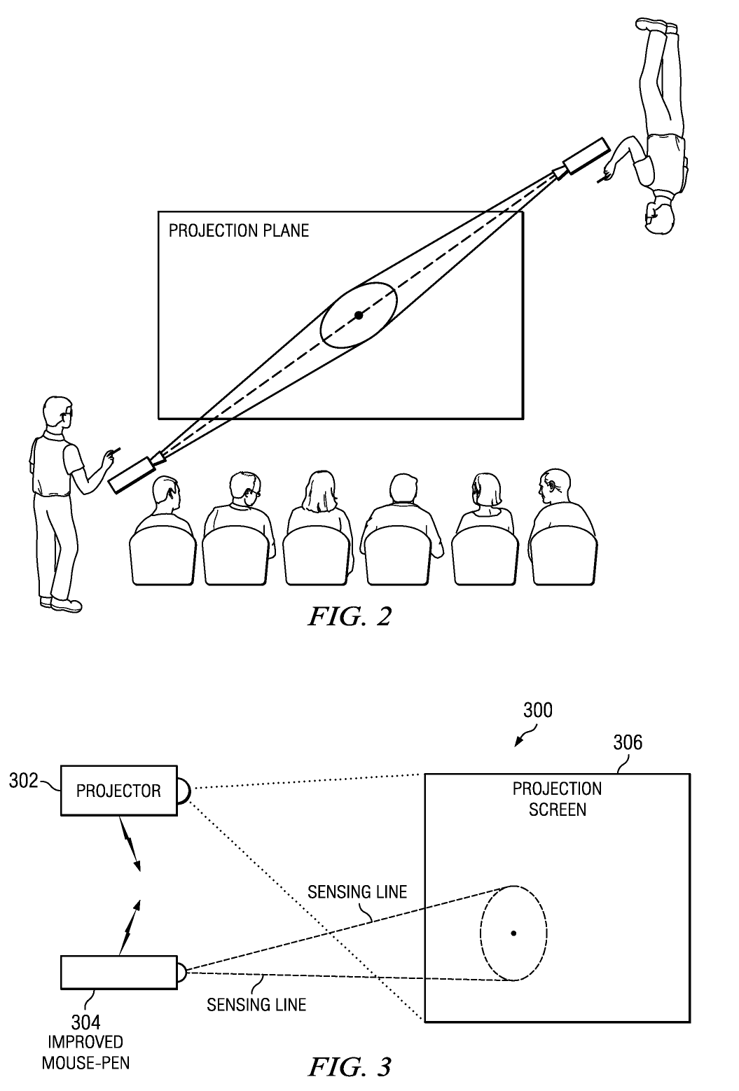

FIG. 2 is an embodiment of an improved mouse-pen system where human motion provides enough constraints to eliminate implausible the mouse-pen locations. The characterization of the conic almost uniquely determines the three-dimensional position of the mouse-pen. The only ambiguity is due to the symmetry of ellipses. FIG. 2 depicts this situation and presents alternative mouse-pen locations. As such, a valid mouse-pen location could be assumed to stay lower than the screen, because users are expected to be standing on the ground. In addition, some amount of smoothness & continuity of the mouse-pen's 3D position over time would help eliminate implausible configurations.

Such a system may be to assist in adapting to the user's distance from the screen. In other words, when the software application is aware of the user's distance from the screen, it can adapt its font & graphics size to maximize ease of reading. Large fonts are preferable when away from the screen. Also, it is capable of adapting to the user's position with respect to the screen. If the user is known to be on the right side, the dialog box can be drawn on the right end of the screen to make it easier to read & to respond to. Similarly, when the user is on the left.

Furthermore, the improved mouse-pen enables three-dimensional effects. Immersive applications, such as, augmented reality and 3D games can directly leverage the user's three-dimensional position. For instance, virtual characters on the screen can orient themselves to maintain an eye-contact with the user. It will also be possible for the users to move naturally around in the room when acting in their virtual world.

As a 3D positioning device, our invention may leverage a DLP and mouse-pen technologies in a very unique way. It does not require any additional hardware components, such as, cameras, inertial or magnetic sensors.

FIG. 3 is an embodiment of a block diagram for an improved mouse-pen system 300. The improved mouse-pen system 300 comprises a projector 302, an improved mouse-pen device 304 and a projection screen 306. The improved mouse-pen device 304 communicates with the projector 302 for calculating the location of the improved mouse-pen device with respect to the projector. The improved mouse-pen device generates a sensing cone and light patterns on the projection screen 306. Utilizing the intensity o f the light and the location with respect to the projector, the three dimensional position of the improved mouse-pen device can be determined.

FIG. 4 is an embodiment of a flow diagram for a method 400 for operating an improved mouse-pen system. The method 400 starts at step 402 and proceeds to step 404. At step 404, the method 400 projects structures light pattern; for example, by using a projector. AT step 406, the method 400 measures the intensity of the light. The measurement is performed by an improved mouse-pen device. The improved mouse-pen may include a photo-diode and may be capable of communicating with a projector. At step 408, the method 400 decides on the next structured light pattern to infer the position and shape of the light sending cone of the improved mouse-pen device. At step 408, the method 400 determines the three dimensional position of the improved mouse-pen device utilizing the location of the improved mouse-pen device with respect to the projector. The method 400 ends at step 412.

While the foregoing is directed to embodiments of the present invention, other and further embodiments of the invention may be devised without departing from the basic scope thereof, and the scope thereof is determined by the claims that follow.

What is claimed is:

1. A method of an improved mouse-pen device, comprising:
projecting structured light pattern;
measuring the intensity of the projected light;
determining the improved mouse-pen location with respect to a projector;
determining the next structured light pattern to infer the position and shape of the light sensing cone of the improved mouse-pen device utilizing the light intensity data and location with respect to the projector; and
determining the three position of the improved mouse-pen device utilizing the inferred position and shape.

2. An improved mouse-pen system, comprising:
a projection screen;
a projector projects structured light pattern on the projector screen;
an improved mouse-pen device infers the position and shape of the light-sensing cone of the light sensing cone of the improved mouse-pen device and determines the three dimensional position of the improved mouse-pen device.

3. A non-transitory computer readable medium comprising software that, when executed perform a method of an improved mouse-pen device, the method comprising:
projecting structured light pattern;
measuring the intensity of the projected light;
determining the improved mouse-pen location with respect to a projector;
determining the next structured light pattern to infer the position and shape of the light sensing cone of the improved mouse-pen device utilizing the light intensity data and location with respect to the projector; and
determining the three position of the improved mouse-pen device utilizing the inferred position and shape.
